(19) United States
(12) Patent Application Publication
(10) Pub. No.: US 2010/0010992 A1
(43) Pub. Date: Jan. 14, 2010

(54) Methods And Systems For Resolving A Location Information To A Network Identifier

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/170,829

(22) Filed: Jul. 10, 2008

(51) Int. Cl. G06F 17/30

(52) U.S. Cl. 707/6; 707/E17.001

(57) ABSTRACT

Methods and systems are described for resolving location information to a network identifier. In one embodiment, a method includes receiving information identifying a geospatial query region. The method also includes generating a query message including an outside-scope, unicast identifier identifying a zone corresponding to a zone region at least partially present in the query region. The method also includes sending the query message to a border node having an outside network interface for receiving the query message and an inside network interface in a network path including a network interface in the zone. The method also includes receiving a response identifying a node having a network interface in the zone.

### RELATED APPLICATIONS

This application is related to the following commonly owned U.S. patent applications, the entire disclosure of each being incorporated by reference herein:

application Ser. No. ______ 11/962,285 (Attorney Docket No 1509/US) filed on Dec. 21, 2007, entitled “METHODS AND SYSTEMS FOR SENDING INFORMATION TO A ZONE INCLUDED IN AN INTERNET NETWORK”;

application Ser. No. ______ (Attorney Docket No 1522/US) filed on even date herewith, entitled “METHODS AND SYSTEMS FOR RESOLVING A GEOSPATIAL QUERY REGION TO A NETWORK IDENTIFIER”; and

application Ser. No. _______ (Attorney Docket No 1524/US) filed on even date herewith, entitled “METHODS AND SYSTEMS FOR RESOLVING A QUERY REGION TO A NETWORK IDENTIFIER”.

### BACKGROUND

In the current domain name system (DNS), a query identifying a region for returning a network identifier of a node associated with the region is not supported. In the current system, performing such a query is impractical. Region information is associated with a node in DNS currently by a LOC record as defined in the Internet Engineering Task Force (IETF) Request for Comments (RFC) 1876. A LOC record is managed by a DNS server representing a DNS domain, such as “example.com”. A LOC record allows an IP address to be resolved to a location/region. A DNS server representing a specified domain can include LOC records from any number of regions. LOC records for any given region can be distributed across the DNS, and thus may be located on any number of DNS servers. That is, there is no DNS server that is authoritative or responsible for a specified region.

Further, applications, such as browsers, often need to know more than a host network address. For example, a browser requires a Uniform Resource Locator (URL) for identifying a service accessed by a host network address. Current DNS provides service records for locating services of various types in a given non-geospatial domain. A DNS naming domain can span more than one subnet and can span multiple, disjoint geospatial regions. There is no standard way of locating a service in a specified geospatial region.

Accordingly, there exists a need for methods, systems, and computer program products for resolving location information to a network identifier.

### SUMMARY

Methods and systems are described for resolving location information to a network identifier. In one embodiment, a method includes receiving information identifying a geospatial query region. The method also includes generating a query message including an outside-scope, unicast identifier identifying a zone corresponding to a zone region at least partially present in the query region. The method also includes sending the query message to a border node having an outside network interface for receiving the query message and an inside network interface in a network path including a network interface in the zone. The method also includes receiving a response identifying a node having a network interface in the zone.

According to another aspect, a method includes receiving a query message identifying a geospatial query region and including an outside-scope, unicast identifier identifying a zone having a zone region at least partially present in the query region. The method also includes locating a resolver service for determining a node in the zone having a node region at least partially present in the query region. The method also includes providing the query message to the resolver service. The method also includes receiving a network identifier of the node from the resolver service. The method also includes sending a query response message including the network identifier.

According to an aspect, a system for resolving location information to a network identifier is disclosed. The system includes a resolver interface component configured to receive information identifying a geospatial query region. The system includes a border node resolver component configured to generate a query message including an outside-scope, unicast identifier identifying a zone corresponding to a zone region at least partially present in the query region. The system includes a border node client component configured to send the query message to a border node having an outside network interface for receiving the query message and an inside network interface in a network path including a network interface in the zone. The system includes a border node resolver component configured to receive a response identifying a node having a network interface in the zone.

According to another aspect, another system for resolving location information to a network identifier is disclosed. The system includes an outside network interface component configured to receive a query message identifying a geospatial query region and including an outside-scope, unicast identifier identifying a zone having a zone region at least partially present in the query region. The system includes an extension detector component configured to locate a resolver service for determining a node in the zone having a node region at least partially present in the query region. The system includes a resolver layer component configured to provide the query message to the resolver service. The system includes a routing layer component configured to receive a network identifier of the node from the resolver service. The outside network interface component is further configured to send a query response message including the network identifier.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for resolving location information to a network identifier according to an embodiment of the subject matter described herein;

FIG. 2 is a block diagram illustrating a system for resolving location information to a network identifier according to another embodiment of the subject matter described herein;

FIG. 3 is a block diagram illustrating a system for resolving location information to a network identifier according to another embodiment of the subject matter described herein;

FIG. 4 is a message flow diagram illustrating a message flow for resolving location information to a network identifier according to another embodiment of the subject matter described herein.

FIG. 5 is a flow diagram illustrating a method for resolving location information to a network identifier according to an embodiment of the subject matter described herein;

FIG. 6 is a block diagram illustrating a system for resolving location information to a network identifier according to another embodiment of the subject matter described herein; and

FIG. 7 is a block diagram illustrating a system for resolving location information to a network identifier according to another embodiment of the subject matter described herein.

### DETAILED DESCRIPTION

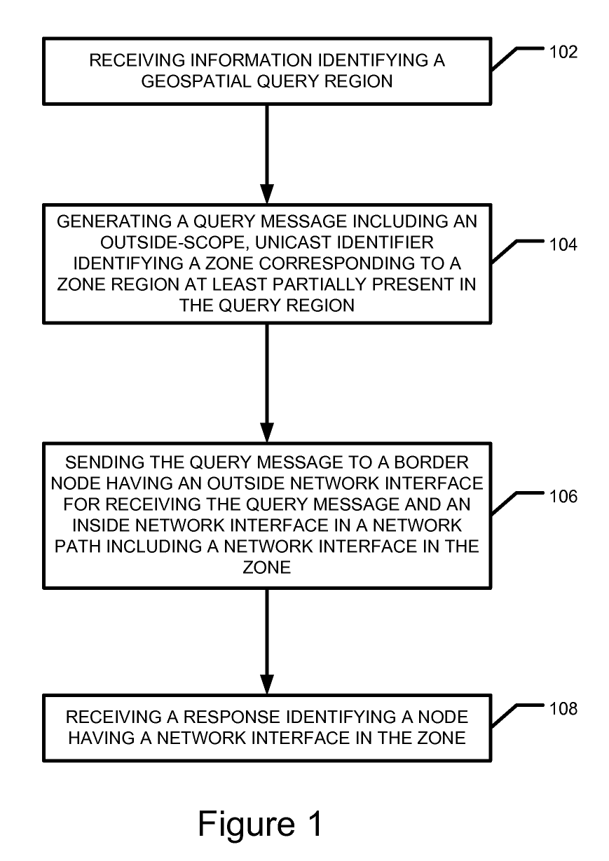

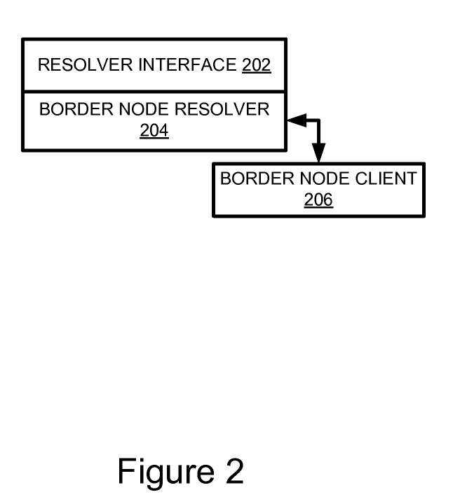

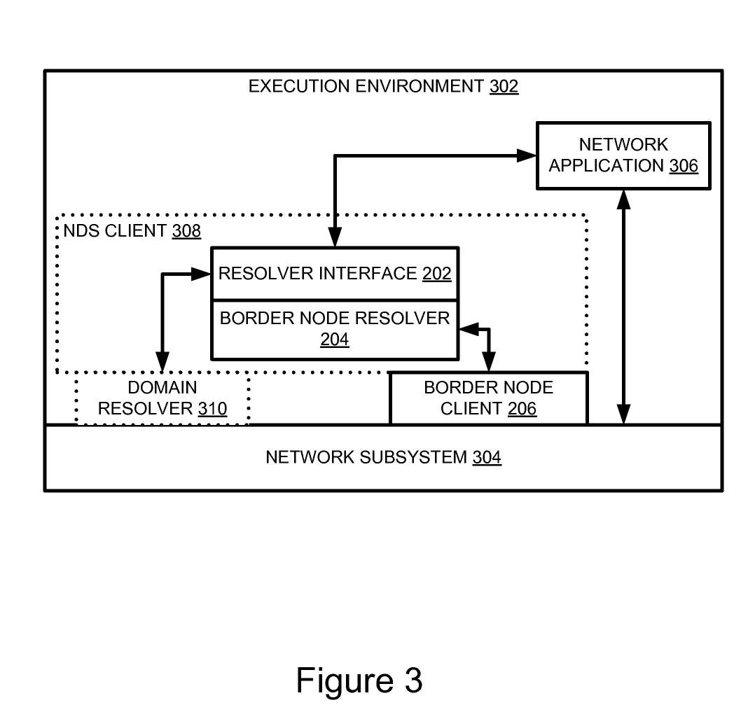

FIG. 1 is a flow diagram illustrating a method for resolving location information to a network identifier according to an exemplary embodiment of the subject matter described herein. FIG. 2 is a block diagram illustrating an arrangement of components for resolving location information to a network identifier according to another exemplary embodiment of the subject matter described herein. FIG. 3 is a block diagram illustrating an arrangement of components providing an execuction environment configured to host the arrangement of components illustrated in FIG. 2. The method illustrated in FIG. 1 can be carried out by, for example, some or all of the components illustrated in FIG. 2, operating in a compatible execution environment, such as the environment illustrated in FIG. 3.

With reference to FIG. 1, in block 102 information identifying a geospatial query region is received. Accordingly, a system for resolving location information to a network identifier includes means for receiving information identifying a geospatial query region. For example, as illustrated in FIG. 2, a resolver interface component 202 is configured to receive information identifying a geospatial query region.

The resolver interface component 202 can be configured to receive information identifying a query region in a variety of forms. For example, the information can include a geospatial identifier. A geospatial identifier includes any identifier that includes a portion that is usable for identifying a region/location of a geospatial domain space. Examples include:
postal://usa.nc.cary.corning-road:111.suite:220.placid
postal://placid.suite:220.corning_road:111.cary.nc.usa
postal://placid.suite:220:corning_road:111.27518.

Each of the above examples is from a geospatial domain space based the US Post Office geospatial domain space that includes postal addresses.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for addressing Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined for specifying regions and locations having a variety of shapes such as a rectangle, circle, oval, or any shape including a closed region. A geospatial identifier can identify a region with disjoint sub-regions by including a geospatial attribute that identifies the sub-regions. For example, the identifier, “40+”, from an identifier domain space including average annual rainfall totals over a specified period identifies a geospatial region including all sub-regions that have an average annual rainfall over 40 inches.

A geospatial identifier can include any of the forms and formats described above. Further a received geospatial identifier can be a network identifier in the form of geospatial network address or in the form of a geospatial name correponding to at least a portion of a network address.

A network identifier is a logical identifier for a communication endpoint on a network. A network identifier includes at least one of a node portion identifying a node having a network interface in an identifiable portion of network and a zone portion identifying the identifiable portion of the network. Network identifiers are described in more detail below. A node can be any device having a network interface, such as, for example, an Ethernet NIC and/or a wireless adapter. The terms “zone” and “domain” are used interchangeably in this document.

An Internet Protocol (IP) address is a network identifier for communicating over an IP network such as the Internet. The domain name system (DNS) includes a set of names that include network identifiers. The DNS system is configured to map a DNS name to a network address. A network identifier can be at least one of a network address and a symbolic identifier of a network address, such as a DNS name. A network address is a network layer address identifier for a network interface (unicast) or a set of interfaces (multicast or broadcast).

A network address, such as an Internet Protocol (IP) address, can include a zone portion also sometimes referred to as a subnet ID, a subnet portion, and/or a domain portion. For example, the partial IP address, 162.195.20, is a zone portion of an IP address that identifies a subnet including nodes with network addresses that begin with the IP address prefix 162.195.20. To more precisely identify a subnet an IP address or a portion of an IP address can be associated with a mask, such as 255.255.255.0, the mask identifies the subnet portion of an IP address via a logical “or” operation performed between each pair of bits identified by bit position in an IP address and the mask.

Analogously, a network name identifying a node, such as a DNS name, can include a zone portion identifying a naming domain identifying a portion of a network. For example, “nc.sceneralabs.com”, can identify a naming domain where a network interface of a node in the naming domain is associated a node portion in the form of a name such as, “placid”. The name “placid” identifies the network interface of the node within the naming domain, “nc.sceneralabs.com”. The complete network name, “placid.nc.sceneralabs.com”, identifies the node when used outside the naming domain.

As discussed above, a network identifier includes a node portion that identifies a node having a network interface in a portion of the network identified by a zone portion. For example, in an IP address, a portion of the address is associated with a particular network interface in the identified subnet, thus identifying the network interface of the node. In the IP address 162.195.20.143 in the subnet 162.195.20.0/255.255.255.0, 143 is the node portion identifying a node have a network interface in the subnet. A subnet is a zone in the network address domain space. In a DNS name the first portion of the name identifies a node having a network interface in an identifiable domain in the DNS name domain space. As indicated, “placid” is the node portion identifying a network interface in the naming domain identified by “nc.sceneralabs.com”, and “placid.nc” is the node portion in a parent naming domain identified by the domain portion, “sceneralabs.com”.

There can be a one to one correspondence between a subnet in a network address domain space and a domain in a naming domain space, but a one to one correspondence is not required. For example, a domain in a naming domain space can be associated with one or more subnets or subnet portions. Further, a subnet can include network interfaces of nodes included in a single domain of a naming domain space or included in more than one naming domain in a naming domain space.

A domain space can include one or more nodes having network identifiers from the domain identifier space. A domain portion of a name from the domain name space, a portion of a network identified by the domain portion, a node portion of the name, and a node identified by the name can be said to be “in” and “included in” the domain space. Further, an identified portion of the network can be referred to as the domain. The node portion of the name, a network interface of the node identified by the node portion, and the node can be said to be “in” and “included in” the domain identified by the domain portion.

Analogously, a subnet portion of a network address from a domain address space, a portion of a network identified by the subnet portion, a node portion of the network address, and the node identified by the network address can be said to be “in” and “included in” the domain space. Further, an identified portion of the network can be referred to as the domain and/or subnet. The node portion of the network address, a network interface of the node identified by the node portion, and the node can be said to be “in” and “included in” the domain and/or subnet identified by the subnet portion

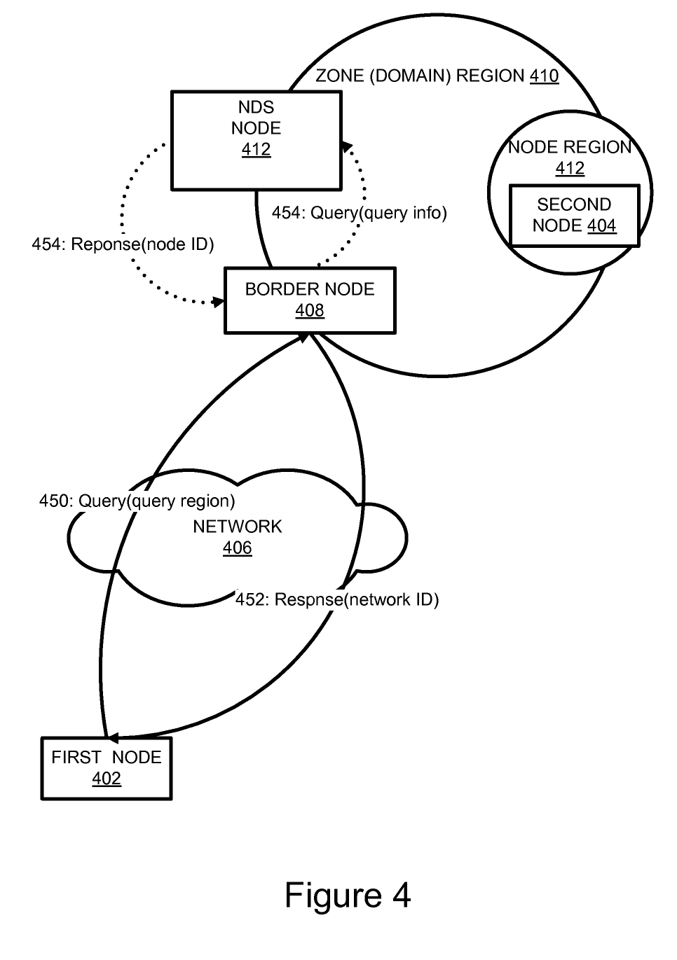

The resolver interface component 202 and other components in FIG. 2 can be adapted for operating in a number of execution environments, such as an execution environment 302 illustrated in FIG. 3. The execution enivorment 302 can be any execution environment suitable for hosting the components illustrated in FIG. 2. For example, a typical execution environment can include a memory for storing instructions and data, a processor for processing the instructions and data, a control program or operating system for managing the memory and processor making the instructions and data accessible to the processor. The execution environment 302 can include other subsystems required by the components of FIG. 2 for any particular configuration. For example, the execution environment 302 can include a network subsystem 304 for providing network communications in interoperation with at least some of the components operating in the execution environmment. Execution environments can be provided by a node or a distributed execution environment can be provided by a collection of nodes. FIG. 4 illustrates a first node 402 providing the execution environment 302 hosting the resolver interface component 202.

The received information, such as a geospatial identifier, identifying a geospatial query region can be received by the resolver interface component 202 from a network application 306 illustrated in FIG. 3. The network application 306 can receive the geospatial identifier from a user and/or from another executable component. Alternatively or additionally, the network application 306 can be configured with information identifying the geospatial query region such as a geospatial identifier. The network application 306 can provide information identifying the geospatial query region to a network directory system (NDS) client 308 configured to communicate with one or more network directory services. The domain name system (DNS) is a well-known NDS for mapping internet node names to internet network addresses and vice versa. The network application 306 can provide the information identifying the geospatial query region to the resolver interface component 202 included in the NDS client 308 for receiving a network identifier, such as a network name and/or a network address. The network application 306 can establish communication with an application operating in an execution environment of a second node 404 in FIG. 4 via a network 406 and/or use the returned network identifier for some other purpose. Alternatively, the network application 306 can provide information identifying the geospatial region as a geospatial network identifier, such as a geospatial network address, to the resolver interface component 202 in the NDS client 308. The resolver interface component 202 can then determine a network identifier in the form of a name and/or network address corresponding to the geospatial network address.

Returning to FIG. 1, in block 104 a query message is generated. The query message includes an outside-scope, unicast identifier identifying a zone corresponding to a zone region at least partially present in the query region. Accordingly, a system for resolving location information to a network identifier includes means for generating a query message including an outside-scope, unicast identifier identifying a zone corresponding to a zone region at least partially present in the query region. For example, as illustrated in FIG. 2, a border node resolver component 204 is configured to generate a query message including an outside-scope, unicast identifier identifying a zone corresponding to a zone region at least partially present in the query region.

A domain or zone can have a geospatial region associated with the domain, referred to herein as a domain region or a zone region. The association between a domain and a domain region can be based on a relationship between the domain region and the domain and/or a node having a network identifier in the domain. The relationship can be of any type, be unidirectional or bidirectional, and can have cardinality. For example, a domain can represent a geospatial region as its domain region and/or one or more nodes in the domain can be included in and/or otherwise represent the domain region of the domain. Further, the relationship associating a domain with a domain region can be of a type based on at least one of an owner, a user, an administrator, a purchase of, a legal right associated with, an authentication service for, an authorization service for, a signer of a digital certificate for one or more of the domain, a node in the domain, and the domain region.

The resolver interface component 202 provides the information identifying the geospatial region to the border node resolver component 204. As stated above, the border node resolver component 204 is configured to generate a query message including an outside-scope, unicast identifier. The message includes an outside-scope, unicast identifier as described in related U.S. Pat. No. 11/962,285, titled “METHODS AND SYSTEMS FOR SENDING INFORMATION TO A ZONE INCLUDED IN AN INTERNET NETWORK”, filed on Dec. 21, 2007, the entire disclosure of which is here incorporated by reference. A message addressed to a destination based on an outside-scope, identifer is routed via a network to a border node of a zone, such as a subnet and/or a symbolic naming domain, identified by the outside-scope, identifier. A border node is a node having an outside network interface for receiving, via a network path outside the scope of the identified zone, a packet addressed with an outside-scope, unicast address. The border node can be configured to provide for processing the packet sent from a node having a network interface outside the identified zone. An outside network interface has a link to a network interface of a node outside the identified zone. The border node has an inside network interface. The inside network interface of the border node can be included in the specified zone. The inside network interface is included in a network path including a network interface in the specified zone.

A zone is a portion of an internet of a given scope. Scope is an indicator of a size, span, or boundary of a portion of a network. For example, a link-local scope is an address span identifying network interfaces within a single link, such as an Ethernet LAN. A particular Ethernet LAN is a zone. A message sent to a destination address with link-local scope is addressed to a network interface of a node included in the particular LAN. A global scope is an address span identifying network interfaces anywhere in the Internet. An interface-local scope is an address span specific to a network interface of a network node. A site-local scope is an address span identifying network interfaces anywhere within a site. Network interfaces of nodes that are not included in an identified zone are outside the identified zone. An outside-scope is an address span identifying network interfaces outside the scope of an identified zone.

A scope can both span a first zone and not span a second zone in the first zone. For example, a site-outside-scope is an address span identifying interfaces anywhere inside a particular site and outside an identified zone in the site. Link-outside-scope and interface-outside-scope are defined analogously. The term outside-scope is used to refer to one or more of site outside-scope, link outside-scope, interface outside-scope and the like. Other types of zones can be specified with an associated outside-scope, and the term outside-scope refers to these other types, as well, unless otherwise noted. In general, a span outside of a zone with a given scope is referred to as the zone outside-scope.

The query message can include the information identifying the geospatial region as a geospatial network address. The geospatial network address can include a node portion for resolving the geospatial identifier to a particular node in the zone identified by the zone portion. Alternatively, the node portion of the geospatial network address can be a matching criterion for identifiying zero or more network identiiers of nodes in the identified zone. According to an aspect, the query message can be generated including a matching criterion based on the information identifying the query region. The query message including the matching criterion can be sent to the border node, wherein the node identified in the response has an attribute matching the matching criterion. For example, the border node resolver component 204 can be configured to generate the query message including a matching criterion based on the information identifying the query region. A border node client component 206 (described more fully below) can be configured to send, to the border node, the query message including the matching criterion, wherein the node identified in the response has an attribute matching the matching criterion.

In one aspect, the absence of a node portion can be for matching all network identifiers in the zone identified by the zone portion. In another aspect, a broadcast node address can be used to match some or all of the network identifiers of nodes in the idenified zone. An outside-scope, unicast identifier can be based on a zone portion of a network address. An outside-scope, unicast identifier can also have an inside-scope as in an outside-scope site-local network address.

Similarly, the information identifying the geospatial region can be a geospatial identifier that also serves as a network identifier in the form of a name for resolving to a network address of one or more nodes included in a network zone identifiied by the zone portion of the geospatial identifier. The node portion can be at least one of a name and a matching criterion for matching one or more node names of nodes having a network interface in the zone identified by the zone portion of the geospatial network identifier. The zone or subnet portion of a network address needed to determine the outside-scope, unicast identifier destination network address of the message can be determined based on a lookup performed on the zone portion of the network name.

Alternatively, the information identifying the geospatial region can be received in the form of a network address. A node portion of a network identifier in the form of a node name or address can be provided with the information identifying the geospatial region for identifying a network identifier of a node associated with the node portion in the identified zone. As described above, any matching criterion for matching one or mode attributes associated with a node in the identified zone can be received. The outside-scope, unicast identifier can be determined based on the zone portion of a geospatial network identifier.

Still further, the information identifying the geospatial region can include a matching criterion for identifying one or more geospatial regions. For example, when a zone portion of a received geospatial identifier includes a matching criterion, one or more outside-scope network identifiers can be determined where the matching criterion in the received geospatial identifier matches a zone portion of a network address where each match identifies a subnet.

According to an aspect, the received information identifying the geospatial region does not include a network identifer or a portion of a network identifier. In this alternative, the outside-scope, unicast address(es) for transmitting the query message can be determined based on a domain space were a domain in the domain space identifies a domain or zone region. The message can be addressed to a border node associated with a domain where the query region is at least partially present in the zone region. The zone can represent a subnet associated with the zone region or. a network name domain associated with the zone region.

Alternatively, as described in application Ser. No. ______ (Attorney Docket No 1522/ US) filed on even date herewith, entitled “METHODS AND SYSTEMS FOR RESOLVING A GEOSPATIAL QUERY REGION TO A NETWORK IDENTIFIER”, an NDS representing the domain space can maintain an assocation between a domain region associated with a domain in the domain space and a domain from another domain space where a node in the other domain space has a node region at least partially present in the domain region. The NDS can return one or more zone identifiers from which one or more outside-scope, unicast addresses can be determined. Additional attributes associated with a domain and/or a node in a domain can be applied in a filter for selecting domain identifiers associated with the geospatial domain space from which outside-scope, unicast addresses can be based.

According to an aspect, the query message generated by the border node resolver component 204 identifies a query region that can include multiple sub-regions based on the information identifying the geospatial region, such as a geospatial identifier, received from the resolver interface component 202. The query message can optionally include a node portion of a network identifier, node portion matching criterion, or any other attributes for identifying a node in a zone identified by query region.

According to an aspect, the outside-scope, unicast identifier is included in a hierarchical domain space and the identified zone is included in at least one of a parent zone identified by at least a portion of the outside-scope, unicast identifier and is a border node of a plurality of zones including the identified zone.

Returning to FIG. 1, in block 106 the query message is sent to a border node having an outside network interface for receiving the query message and an inside network interface in a network path including a network interface in the zone. Accordingly, a system for resolving location information to a network identifier includes means for sending the query message to a border node having an outside network interface for receiving the query message and an inside network interface in a network path including a network interface in the zone. For example, as illustrated in FIG. 2, a border node client component 206 is configured to send the query message to a border node having an outside network interface for receiving the query message and an inside network interface in a network path including a network interface in the zone.

The border node client component 206 can be configured to communicate with a border node on behalf of various applications/components. The border node resolver component 204 can interoperate with the border node client component 206 for sending the query to a border node for a zone identified based on the outside-scope, unicast address determinded based on the received geospatial identifier. The message can include a node porton of a network identifier or other matching attribute(s) for matching a node in the zone or portion of the zone identified by the outside-scope, unicast address.

In FIG. 3 the border node client component 206 can be configured to establish communication with a border node of the identified zone region via a connection such as a Transmission Control Protocol (TCP) connection or via connectless communication such as supported by User Datagram Protocol (UDP). The connection and/or connectionless communication can be established by a network protocol stack such as a TCP/IP stack including an Ethernet link layer and an Ethernet physical layer media. The network stack can be included in the network subsystem 304 operating in the execution environment 302.

FIG. 4 illustrates the first node 402 providing the execution environment 302 for hosting the components illustrated in FIG. 2 adapted for operating in the execution environment 302. The border node client component 206 sends the generated message, illustrated as a query message 450, via the network subsystem 304 to the network 406 for routing to a border node 408 of a zone region 410 identified by the outside-scope, unicast address based on the information identifying the geospatial region received by the resolver interface component 202. The border node 408 provides for determining a network identifier of a node of the zone region 410 based on the message as described below in detail. The border node 408 further provides for transmitting a response, illustrated as a response 452, including a network identifier of a node in the zone of the zone region 410 matching the query, such as the the second node 404. The response 452 to the query message 450 is tranported via the network 406 to the first node 402.

FIG. 4 illustrates the second node 404 having a node region 412. The second node 404 can be included in the node region 412 and/or can represent the region through another type of association. The association between a node and a node region can be based on any relationship between the node region and the node. The relationship can be of any type, be unidirectional or bidirectional, and can have cardinality. For example, the relationship associating a node with a node region can be of a type based on at least one of an owner, a user, an administrator, a domain and/or domain region including, a purchase of, a legal right associated with, an authentication service for, an authorization service for, a signer of a digital certificate for one or more of the node and the node region.

At least one of the matching conditions for determining a node can be that the node has a node region at least partially present in the query region. One or more network identifiers can be included in the response and/or one or more responses can be received from one or more zone regions as provided by a border node of each zone region.

According to an aspect, the query message can be formatted according to a publish-subscribe protocol. For example, the border node resolver component 204 can be configured to format the query message according to a publish-subscribe protocol. The query message can also be an asynchronous message. For example, the border node client component 206 can be configured to send the query message as an asynchronous message.

Asynchronous messages can be included in a publish-subscribe system. A presence protocol is a specialized publish-subscribe protocol including a status field. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. While the various presence aware IM applications described above may user proprietary architectures and protocols to implement their presence service components, each of the applications use presence architectures and protocols that are consistent with the presence model and protocols described in RFC 2778 and RFC 2779 in terms of features and function. In another aspect, the query message is formatted according to a domain name system (DNS) protocol or an analog and the resolver service includes a network directory service.

Returning to FIG. 1, in block 108 a response is received, the response identifies a node having a network interface in the zone. Accordingly, a system for resolving location information to a network identifier includes means for receiving a response identifying a node having a network interface in the zone. For example, as illustrated in FIG. 2, the border node resolver component 204 is configured to receive a response identifying a node having a network interface in the zone.

The response identifying a node included in the zone is received by the border node resolver component 204 via the border node client component 206 as illustrated in FIG. 2. The border node client component 206 is configured to route messages from a border node to a component/application identified in the message. In FIG. 3, the response message 452 is received by the network subsystem 304 from the network 406 and routed to the border node client component 206 for routing. Alternatively, the response message 452 can be addressed for routing by the network subsystem 304 to the border node resolver component 204 bypassing the border node client component 206. For example, the query message can identify a TCP/IP port opened by the network subsystem 304 on behalf of the border node resolver component 204 for listening for the response to the query message. The port number can be included in the query message for addressing the response message.

The network identifier can be returned to the network application 306 from the border node resolver component 204 directly or via the resolver interface component 202 originally invoked by the network application 306. The network identifier of the second node 404 can be a network address allowing the network application 306 to establish communication with the second node 404 via the network 406 based on the network identfier as a network address. Alternatively or additionally, the returned network identifier can be a network name of the second node 404. The network name can be resolved to a network address for communicating with the second node 404. The network identifier as either a network address of a network name can be included in a URL for accessing a resource provided by the second node 404. Additionally or alternatively, the network identifier can be presented via a user interface to a user. For example, information related to the second node 404 can be presented in association with the query region, for example, on a map. In another aspect, the query region is at least partially present in a zone region identified by a zone in a first domain space, wherein the identified node has a node region at least partially present in the zone region and at least partially present in the query region.

According to an aspect, in response to receiving the response identifying the node, a message can be sent to the identified node with a destination network address based on a network identifier included in the response. For example, a network subsystem component 304 can be configured to, in response to receiving the response identifying the network node, send, to the identified node, a message with a destination network address based on a network identifier included in the response.

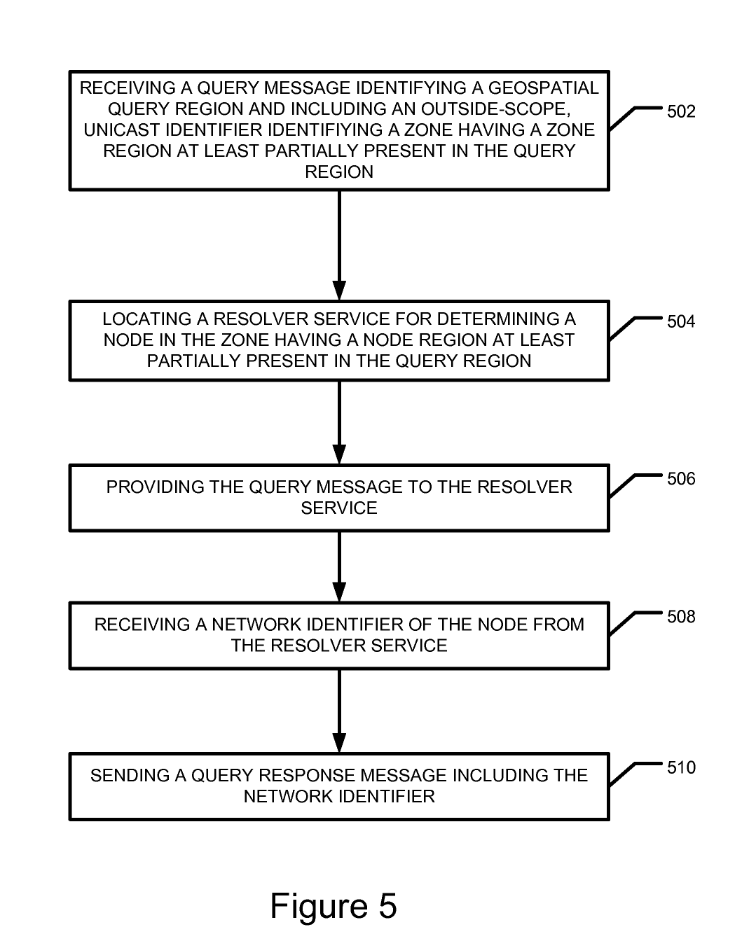

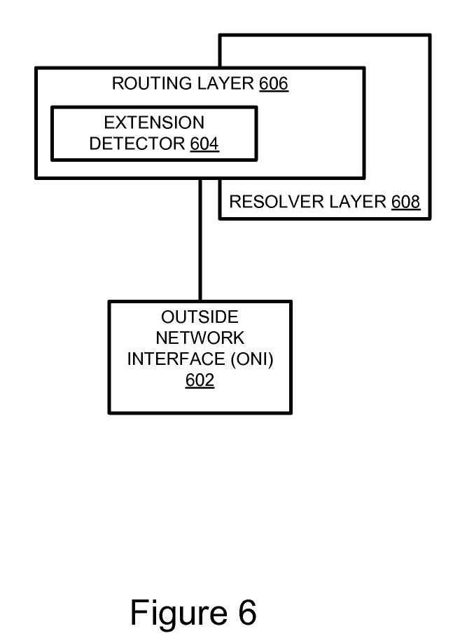

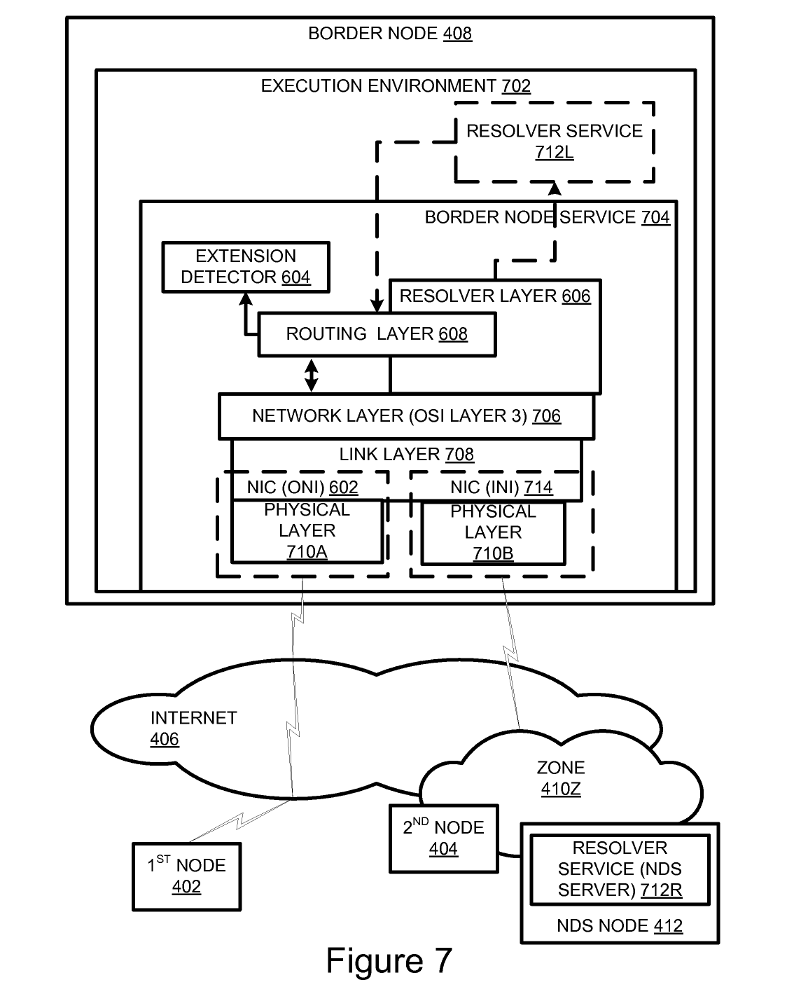

FIG. 5 is a flow diagram illustrating a method for resolving location information to a network identifier according to an exemplary embodiment of the subject matter described herein. FIG. 6 is a block diagram illustrating an arrangement of components for resolving location information to a network identifier according to another exemplary embodiment of the subject matter described herein. FIG. 7 is a block diagram illustrating an arrangement of components providing an execuction environment configured to host the arrangement of components illustrated in FIG. 2. The method illustrated in FIG. 5 can be carried out by, for example, some or all of the components illustrated in FIG. 6, operating in a compatible execution environment, such as the environment illustrated in FIG. 7.

With reference to FIG. 5, in block 502 a query message is received. The query message identifies a geospatial query region and including an outside-scope, unicast identifier identifying a zone having a zone region at least partially present in the query region. Accordingly, a system for resolving location information to a network identifier includes means for receiving a query message identifying a geospatial query region and including an outside-scope, unicast identifier identifying a zone having a zone region at least partially present in the query region. For example, as illustrated in FIG. 6, an outside network interface component (ONI) 602 is configured to receive a query message identifying a geospatial query region and including an outside-scope, unicast identifier identifying a zone having a zone region at least partially present in the query region.

For example, the query message 450 can be sent by the border node client component 206 operating in the execution environment 302 provided by the first host 402, and can be received by the ONI 602 illustrated in FIG. 6. The ONI 602 and other components in FIG. 6 can be adapted for operating in an execution environment, such as an execution environment 702 hosting a border node service 704 illustrated in FIG. 7. The execution environment 702 can be provided, for example, by the border node 408 illustrated in FIG. 4. According to an aspect, the border node 408 can receive the query message 450, and the border node 408 can have an outside network interface, such as the ONI 602, for receiving the query message 450 and an inside network interface in a network path including a network interface in the identified zone, illustrated as a zone 410Z in FIG. 7.

In FIG. 7, the ONI 602 is illustrated as a network interface card (NIC) such as wired or wireless network adapter. An ONI can include any component configured to receive a query message including layers of a receiving network stack such as a network layer 706 corresponding to layer 3 of the Open Systems Interconnect (OSI) model or a component configured to receive the query message from a layer of the network stack such as an extension detector component 604. As illustrated, the ONI 602 can include a portion of a link layer 708 and a physical layer component 710A.

As described above, a query message can include information identifying the geospatial region, such as a geospatial identifier. The query message 450 can be routed from the first node 402 via the internet 406 to any border node of the zone 410Z having the zone region 410 identified by an outside-scope, unicast address included as a destination address in the query message 450. The zone 410Z has the zone region 410 and the query region is at least partially present in the zone region 410. As described above, the outside-scope, unicast identifier can be determined based on the information identifying the geospatial region, such as a geospatial identifier, such that the query region is at least partially present in the zone region 410. As described above, a network address of a particular border node is not required since the message can be routed to the border node 408 based on the zone portion of the outside-scope, unicast address. The outside-scope, unicast address can be a geospatial network identifier identifying the zone region 410. The query region and the zone region can be the same region. In such a case, the outside-scope, unicast address can serve as the information identifying the geospatial region.

Returning to FIG. 5, in block 504 a resolver service is located for determining a node in the zone having a node region at least partially present in the query region. Accordingly, a system for resolving location information to a network identifier includes means for locating a resolver service for determining a node in the zone having a node region at least partially present in the query region. For example, as illustrated in FIG. 6, an extension detector component 604 component is configured to locate a resolver service for determining a node in the zone having a node region at least partially present in the query region.

For example, the extension detector component 604 can be configured to receive query message information based on the query message received by the ONI 602. The extension detector component 604 is configured to locate a resolver service for processing the query. A message addressed with an outside-scope, unicast address for routing to a border node can include a resolver service request. The resolver service request can be determined based on a variety of attributes of a received message including an indicator in a message such as a prespecified field and/or a detected format of a message. For example, a query message can include a transport layer extension header indicating a message type for determining a resolver service to process the message as described in application Ser. No. 11/962,285 (Attorney Docket No 1509/ US) filed on Dec. 21, 2007, entitled “METHODS AND SYSTEMS FOR SENDING INFORMATION TO A ZONE INCLUDED IN AN INTERNET NETWORK”.

The extension detector component 604 can be configured to receive and locate a for processing messages of various types. Alternatively, multiple extension detector components can be provided, such that each extension detector component is configured to locate a service to process a message based on an attribute of a message, such as its format, or an extension header type or an extension header value. In one alternative, an extension detector component can be provided for each message type that can be received. In this case and in some other alternatives, an extension detector component can be a service for processing the message.

A received query message can be detected by a component, such as a resolver layer component 606 and/or a routing layer component 608, configured to communicate with the extension detector component 604. For example, the routing layer component 608 or the resolver layer component 606 can be configured to receive a message received by the ONI 602 via the network layer component 706 as processed by the components of the network stack. The routing layer component 608 or the resolver layer component 606 can be configured to invoke the extension detector 604 to detect an extentsion and to locate a service. Alternatively, the routing layer component 608 or the resolver layer component 606 can be configured to detect an extension and, in response, route the message to an extension detector, such as the extension detector 604.

Based on an attribute of the message, a service for processing the message is located. The service can be, for example, a web service, a File Transfer Protocol (FTP) service, a messaging service, a file service, a database service, a remote procedure call service, or any other type of service. According to an aspect, locating a service includes detecting a service indicator included in the query message, the service indicator identifying a resolver service and/or a resolver service type for processing the query. For example, the extension detector component 604 can be configured to detect a service indicator included in the query message, the service indicator identifying a resolver service for performing the query. The extension detector component 604 can perform a lookup or call a component (local or remote) for mapping the service type identifier to an identifer of a local or remote component configured to provide the identified type of service. The service type can be identified based on any number of attributes including: one or more of a detected format of a message, a detected field in a message, a detected value in a field, and/or a second message associated with the query message including information for identifying the resolver service.

The query message can be formatted according to messaging protocol for interoperating with a resolver service such as a DNS server or other network directory system (NDS) server. Based on the detected format a resolver service can be identified as the service type for processing the query message. An identifier of a particular resolver service 712 (such as a local resolver service 712L operating in the execution environment 702 of the border node 408 or a remote resolver Service 712R operating in an execution environment of a NDS node 412) can be stored in a configuration store (not shown) accessible to the border node. 408. FIG. 7 illustrates that the resolver service 712R can be an NDS server, such as a DNS server. The same is true for resolver service 712L. The extension detector component 604 can locate the resolver service based on its type and provide the message to the resolver layer component 606 for deliverying the query message as processed to the located resolver service. Alternatively or additionally, the extension detector component 604 can be configured to locate an identifier of a particular service such as the resolver service 712R in the NDS node 412 in the zone 410Z or the resolver service 712L operating in the same execution environment 702 as the extension detector component 604.

Returning to FIG. 5, in block 506 the query message is provided to the resolver service. Accordingly, a system for resolving location information to a network identifier includes means for providing the query message to the resolver service. For example, as illustrated in FIG. 6, the resolver layer component 606 is configured to provide the query message to a resolver service.

The resolver layer component 606 can be configured to send the query message (or a message based on the query message) to the resolver service. According to an aspect, providing the query message includes sending, by the resolver layer component 606, the query message to a resolver service operating in an execution environment of a node hosting the resolver layer and the resolver service. For example, the resolver layer component 606 can be a code library in the execution environment 702 invoked by the extension detector component 604 for providing query message information to the resolver service 712L.

The resolver layer component 606 can be configured to send the query message by formatting query message data in a format compatible with a resolver service. The resolver layer component 606 can include an interface compatible with a resolver service for communicating the formatted data to the resolver service. The resolver layer component 606 is illustrated in FIG. 6 as configured to provide the query message to the local resolver service 712L. For example, the resolver layer component 606 can be configured to invoke the resolver service 712L via a programming interface. Alternatively, the resolver layer component 606 can be configured to invoke the resolver service 712L via an interprocess communication mechansim provided by the execution environment 702 such as a message query or pipe.

Alternatively, the resolver layer component 606 can be configured to send the message according to a protocol compatible with a resolver service via a network stack for transmitting the query message to a remote resolver service, such as the NDS server 712R operating in the NDS node 412. For example, the resolver layer component 606 can be configured as an application protocol layer compatible with a located resolver service for providing the query message (or information based on the query message) to a layer of a network stack such as the network layer 706 for transmitting via zone 410Z of the zone region 410 to another node providing access to the located resolver service, such as the NDS node 412 hosting NDS server 712R. For example, the resolver layer 606 can be a DNS protocol layer for communicating with the NDS server 712R, provided as a DNS server.

According to an aspect, providing a query message to a resolver service can include generating a second query message based on the received query message, determining a service address associated with the resolver service, and transmitting the second query message to the resolver service based on the determined service address. For example, the resolver layer component 606 can be configured to generate a second query message based on the received query message and for determining a service address associated with the resolver service. The resolver layer component 606 can be configured to transmit the second query message, illustrated as query message 454 sent to the node 412 in FIG. 4, to the resolver service based on the determined service address. In another aspect, the second query message is formatted according to a domain name system (DNS) protocol. For example, the resolver layer component 606 can be configured to format the second query message according to a domain name system (DNS) protocol as described above.

Returning to FIG. 5, in block 508 a network identifier of the node is received from the resolver service. Accordingly, a system for resolving location information to a network identifier includes means for receiving a network identifier of the node from the resolver service. For example, as illustrated in FIG. 4, the routing layer component 608 is configured to receive a network identifier of the node from the resolver service.

A resolver service 712 can be configured to generate a response inclulding a network identifier of a node based on the query message. For example, the query message can identify only the query region. A resolver service 712 can return all network identifiers in the zone 410Z based on the query region being at least partially present in the zone region 410. Alternatively, a resolver service 712 can be configured to maintain node region information identifying a node region for one or more nodes in the zone 410Z. A resolver service 712 can be configured to include in a response message the network identifiers of nodes having node regions that are at least partially present in the query region.

According to an aspect, the query message can include a node portion of a network identifier of a node in an address format or as a symbolic name asociated with an address. The resolver service 712 can be configured to locate a node with a matching node portion and include the node's network identiier, in some cases including only the node portion, in the response. The resolver service 712 can be configured to send an identifier of a node witih a matching node portion of a network identifier only when the corresponding node has a node region at least partially present in the query region.

Other attributes can be included in the query message and/or processed as configuration data by the resolver service 712. For example, the resolver service 712 can be configured to identify a node or nodes that match the matching criterion in the query message. The resolver service 712 can be further configured to only include the identifiers of the nodes that are detected as currently active in the zone. Whether a node is active can be determined by “pinging” the node or via a presence service providing a status of a node. According to an aspect, the resolver service 712 can identify one or more nodes that match the matching criterion in the query message. The resolver service 712 can be further configured to return only the identifier(s) of the node or nodes with a specified set of available resources such as storage, memory, processor capacity, etc.

The identification of a node based on the query message can be performed by a resolver service operating across more than one node. For example, the NDS server 712R can be configured to identify one or more nodes in the zone that match the criterion in the query message. A a component in the border node 408 such as the extension detector component 604 or the resolver service 712L can alter the returned network identifier or identifiers based on configuration data and status/state information accessible within the zone 410Z.

Regardless of the manner in which the node in the zone 410Z is identified, a response including the network identifier is received by the routing layer component 608 from a resolver service, such as the resolver service 712L and/or the NDS server 712R. A response message 456 can be a response sent from the NDS server 712R from the NDS node 412. The response message 456 can be transmitted by the zone 410Z to the border node 408. The response message 456 is received by the routing layer 608 via the network layer 706 (and optionally the resolver layer 606) as processed by an inside network interface (INI) 714. The INI 714, as illustrated in FIG. 7, can be a second NIC 714 including a physical layer 710B and at least a portion of a link layer, such as the link layer 708. The INI 714 is in a network path including the border node 408 and each node included in the zone 410Z having the zone region 410 represented by the border node 408.

Returning to FIG. 5, in block 510 a query response message is sent, the query message including the network identifier. Accordingly, a system for resolving location information to a network identifier includes means for sending a query response message including the network identifier. For example, as illustrated in FIG. 6, the outside network interface component (ONI) 602 is configured to send a query response message including the network identifier.

The routing layer component 608 can be configured to relay the response received from the resolver service 712 via the network stack (INI 714 including the physical layer 710B and link layer 708, and network layer 706) from the zone 410Z to the internet 406 via the network stack including the ONI 602. Alternatively, the received response can be provided to the resolver layer component 606 or the extention detector component 604 for relaying.

According to an aspect, instead of relaying the response; at least one of the routing layer component 608, the resolver layer component 606, and the extension detector component 604 can be configured to generate a second response including the network identifier. The second response can be based on the received response. For example, a protocol for communicating with the NDS server 712R can have a different format than the protocol for formatting the query message and associated response.

According to an aspect, the query response message can be an asynchronous message. For example, the resolver layer component 606 can be configured to send the response message response as an asynchronous message. Further, the query response message can be formatted according to a publish-subscribe protocol. For example, the resolver layer component 606 can be a publish-subscribe protocol layer configured to format the query message response as a notification or a publish message according to a publish-subscribe protocol. In another aspect, the query response message is addressed with an outside-scope, unicast destination address.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for resolving location information to a network identifier, the method comprising:
receiving information identifying a geospatial query region;
generating a query message including an outside-scope, unicast identifier identifying a zone corresponding to a zone region at least partially present in the query region;
sending the query message to a border node having an outside network interface for receiving the query message and an inside network interface in a network path including a network interface in the zone; and
receiving a response identifying a node having a network interface in the zone.

2. The method of claim 1 wherein the query region is at least partially present in a zone region identified by a zone in a first domain space, wherein the identified node has a node region at least partially present in the zone region and at least partially present in the query region.

3. The method of claim 1 wherein the information includes a geospatial identifier identifying the query region

4. The method of claim 3 wherein the geospatial identifier is a network identifier including at least one of a network address and a network name, wherein the network name is resolvable to the network address and the network address is resolvable to the network name.

5. The method of claim 3 wherein the outside-scope, unicast identifier is based on the geospatial identifier.

6. The method of claim 1 wherein the outside-scope, unicast identifier is at least one of an outside-scope, unicast network address and an outside-scope, unicast network zone name.

7. The method of claim 1 wherein the query message is formatted according to a publish-subscribe protocol.

8. The method of claim 1 wherein the query message is an asynchronous message.

9. The method of claim 1 wherein the outside-scope, unicast identifier is included in a hierarchical domain space and the identified zone is included in at least one of a parent zone identified by at least a portion of the outside-scope, unicast identifier and is a border node of a plurality of zones including the identified zone.

10. The method of claim 1 further comprising:
generating the query message including a matching criterion based on the information identifying the query region; and
sending, to the border node, the query message including the matching criterion, wherein the node identified in the response has an attribute matching the matching criterion.

11. The method of claim 1 further comprising in response to receiving the response identifying the network node, sending, to the identified node, a message with a destination network address based on information included in the response identifying the node.

12. A method for resolving location information to a network identifier, the method comprising:
receiving a query message identifying a geospatial query region and including an outside-scope, unicast identifier identifying a zone having a zone region at least partially present in the query region;
locating a resolver service for determining a node in the zone having a node region at least partially present in the query region;
providing the query message to the resolver service;
receiving a network identifier of the node from the resolver service; and
sending a query response message including the network identifier.

13. The method of claim 12 wherein a border node receives the query message, the border node having an outside network interface for receiving the query message and an inside network interface in a network path including a network interface in the identified zone.

14. The method of claim 13 wherein providing the query message includes routing, the query message to the resolver service operating in an execution environment of the border node

15. The method of claim 12 wherein the query region is identified by a geospatial identifier.

16. The method of claim 15 wherein the geospatial identifier is at least a portion of a network identifier identifying the zone.

17. The method of claim 16 wherein the network identifier is at least one of a network address and a network name wherein the network name is resolvable to the network address and the network address is resolvable to the network name.

18. The method of claim 12 wherein locating a resolver service includes detecting a service indicator included in the query message, the service indicator identifying a resolver service for performing the query.

19. The method of claim 12 wherein providing the query message to the resolver service includes:
generating a second query message based on the received query message;
determining a service address associated with the resolver service; and
transmitting the second query message to the resolver service based on the determined service address.

20. The method of claim 19 wherein the second query message is formatted according to a domain name system (DNS) protocol.

21. The method of claim 12 wherein the query response message is addressed with an outside-scope, unicast destination address.

22. The method of claim 12 wherein at least one of the query message and the query response message is an asynchronous message.

23. The method of claim 12 wherein at least one of the query message and the query response message is formatted according to a publish-subscribe protocol.

24. The method of claim 12 further comprising:
receiving a matching criterion in the query message;
providing for determining a network identifier of a node in the zone having an attribute matching the matching criterion; and
sending the response including the network identifier, in response to the determination of the network identifier of the node matching the matching criterion.

25. A system for resolving location information to a network identifier, the system comprising:
means for receiving information identifying a geospatial query region;
means for generating a query message including an outside-scope, unicast identifier identifying a zone corresponding to a zone region at least partially present in the query region;
means for sending the query message to a border node having an outside network interface for receiving the query message and an inside network interface in a network path including a network interface in the zone; and
means for receiving a response identifying a node having a network interface in the zone.

26. A system for resolving location information to a network identifier, the system comprising:
a resolver interface component configured to receive information identifying a geospatial query region;
a border node resolver component configured to generate a query message including an outside-scope, unicast identifier identifying a zone corresponding to a zone region at least partially present in the query region;
a border node client component configured to send the query message to a border node having an outside network interface for receiving the query message and an inside network interface in a network path including a network interface in the zone; and
the border node resolver component configured to receive a response identifying a node having a network interface in the zone.

27. The system of claim 26 wherein the query region is at least partially present in a zone region identified by a zone in a first domain space, wherein the identified node has a node region at least partially present in the zone region and at least partially present in the query region.

28. The system of claim 26 wherein the information includes a geospatial identifier identifying the query region

29. The system of claim 28 wherein the geospatial identifier is a network identifier including at least one of a network address and a network name, wherein the network name is resolvable to the network address and the network address is resolvable to the network name.

30. The system of claim 28 wherein the outside-scope, unicast identifier is based on the geospatial identifier.

31. The system of claim 26 wherein the outside-scope, unicast identifier is at least one of an outside-scope, unicast network address and an outside-scope, unicast network zone name.

32. The system of claim 26 wherein the border node resolver component is configured to format the query message according to a publish-subscribe protocol.

33. The system of claim 26 wherein the border node client component is configured to send the query message as an asynchronous message.

34. The system of claim 26 wherein the outside-scope, unicast identifier is included in a hierarchical domain space and the identified zone is included in at least one of a parent zone identified by at least a portion of the outside-scope, unicast identifier and is a border node of a plurality of zones including the identified zone.

35. The system of claim 26 wherein the border node resolver component is configured to generate the query message including a matching criterion based on the information identifying the query region; and the border node client component is configured to send, to the border node, the query message including the matching criterion, wherein the node identified in the response has an attribute matching the matching criterion.

36. The system of claim 26 further comprising a network subsystem component configured to, in response to receiving the response identifying the network node, send, to the identified node, a message with a destination network address based on a network identifier included in the response.

37. A system for resolving location information to a network identifier, the system comprising:
means for receiving a query message identifying a geospatial query region and including an outside-scope, unicast identifier identifying a zone having a zone region at least partially present in the query region;
means for locating a resolver service for determining a node in the zone having a node region at least partially present in the query region;
means for providing the query message to the resolver service;
means for receiving a network identifier of the node from the resolver service; and
means for sending a query response message including the network identifier.

38. A system for resolving location information to a network identifier, the system comprising:
an outside network interface component configured to receive a query message identifying a geospatial query region and including an outside-scope, unicast identifier identifying a zone having a zone region at least partially present in the query region;
a extension detector component configured to locate a resolver service for determining a node in the zone having a node region at least partially present in the query region;
a resolver layer component configured to provide the query message to the resolver service;
a routing layer component configured to receive a network identifier of the node from the resolver service; and
the outside network interface component configured to send a query response message including the network identifier.

39. The system of claim 38 further comprising an inside network interface in a network path including a network interface in the identified zone.

40. The system of claim 38 wherein the query region is identified by a geospatial identifier.

41. The system of claim 40 wherein the geospatial identifier is at least a portion of a network identifier identifying the zone.

42. The system of claim 41 wherein the network identifier is at least one of a network address and a network name wherein the network name is resolvable to the network address and the network address is resolvable to the network name.

43. The system of claim 38 wherein the extension detector component is configured to detect a service indicator included in the query message, the service indicator identifying a resolver service for performing the query.

44. The system of claim 38 wherein the resolver layer component is configured to generate a second query message based on the received query message; determining a service address associated with the resolver service; and the resolver layer is configured to transmit the second query message to the resolver service based on the determined service address.

45. The system of claim 44 wherein the resolver layer component is configured to format the second query message according to a domain name system (DNS) protocol.

46. The system of claim 38 wherein the resolver layer component is configured to route the query message to the resolver service operating in an execution environment of a node hosting the resolver layer component and the resolver service.

47. The system of claim 38 wherein the query response message is addressed with an outside-scope, unicast destination address.

48. The system of claim 38 wherein the routing layer component is configured to send the query message as an asynchronous message.

49. The system of claim 38 wherein the routing layer component is configured to format the query message according to a publish-subscribe protocol.

50. The system of claim 38 wherein:
the outside network interface component is configured to receive a matching criterion in the query message;
the extension detector component is configured to determine a network identifier of a node in the zone having an attribute matching the matching criterion; and
the outside network interface component is configured to send the response including the network identifier, in response to the determination of the network identifier of the node matching the matching criterion.

51. A computer readable medium embodying a computer program, executable by a machine, for resolving location information to a network identifier, the computer program comprising executable instructions for:
receiving information identifying a geospatial query region;
generating a query message including an outside-scope, unicast identifier identifying a zone corresponding to a zone region at least partially present in the query region;
sending the query message to a border node having an outside network interface for receiving the query message and an inside network interface in a network path including a network interface in the zone; and
receiving a response identifying a node having a network interface in the zone.

52. A computer readable medium embodying a computer program, executable by a machine, for resolving location information to a network identifier, the computer program comprising executable instructions for:
receiving a query message identifying a geospatial query region and including an outside-scope, unicast identifier identifying a zone having a zone region at least partially present in the query region;
locating a resolver service for determining a node in the zone having a node region at least partially present in the query region;
providing the query message to the resolver service;
receiving a network identifier of the node from the resolver service; and
sending a query response message including the network identifier.
